(19) United States
(12) Patent Application Publication
(10) Pub. No.: US 2021/0112843 A1
(43) Pub. Date: Apr. 22, 2021

(54) Composition for a Cannabinoid-Infused Comestible and Method of Manufacturing Thereof

(71) Applicant: David Delpiano, Atlanta, GA (US)

(72) Inventor: David Delpiano, Atlanta, GA (US)

(21) Appl. No.: 17/074,423

(22) Filed: Oct. 19, 2020

Related U.S. Application Data
(60) Provisional application No. 62/916,566, filed on Oct. 17, 2019.

(51) Int. Cl. A23L 33/105; A23L 29/00; A23L 27/20; A23L 33/15

(52) U.S. Cl. CPC A23L 33/105; A23L 33/15; A23L 27/20; A23L 29/04

(57) ABSTRACT

A cannabinoid-infused comestible combines a quantity of water-soluble vitamin E TGPS with a quantity of Cannabis extract oil such as cannabidiol (CBD) isolate, broad spectrum CBD, or full spectrum CBD extract oil at a ratio of 7:1. A quantity of water or hemp seed oil may be used as a diluting agent. At least one flavoring agent and at least one fatty acid may further be included. In a method of manufacture of the cannabinoid-infused comestible, the quantities of Cannabis extract oil and TGPS are heated at a specified temperature range, combined, and agitated to homogenize. The heated homogenized mixture is then added to a quantity of heated water and further agitated until complete dissolution is attained.

The current application claims a priority to the U.S. Provisional Patent application Ser. No. 62/916,566 filed on Oct. 17, 2020. The current application is filed on Oct. 19, 2020, whereas Oct. 17, 2020 and Oct. 18, 2020 were on a weekend.

### FIELD OF THE INVENTION

The present invention relates generally to comestibles. More particularly, the present invention relates to the production of comestible cannabidiol (CBD) infused products.

### BACKGROUND OF THE INVENTION

Since the 2018 Farm Bill made all hemp-based CBD products legal in the U.S., interest in Cannabis-infused comestible products has been on the rise. The Cannabis plant comprises a wide variety of chemicals and compounds known as cannabinoids. Cannabinoids, the psychoactive ingredients of Cannabis, can alter neurotransmitter release in the brain and can be useful in the practice of medicine. The right amount of CBD can provide relief for a variety of ailments such as anxiety, stress, inflammation, many forms of pain such as headaches, joint pain, muscle pain, and back pain, and can also help with sleep, nausea, hot flashes, digestive issues, and cramps. Edible forms of Cannabis are considered discreet and effective options for receiving the medicinal effects of Cannabis without exposure to the harmful effects of inhaling smoke. Depending on the method and formulation on how it is administered, the effects of the drug on a human body may vary. For example, current available formulations of a CBD shot, oil and gummies, may take up to one hour to absorb into a human body. Furthermore, typical available CBD formulations have a bioavailability of approximately 30 percent. Thus, for example, if 100 grams of CBD is administered into a human body, approximately 30-35 grams of CBD is absorbed. Thus, an efficient and effective method for administering CBD infused edibles is needed in the field of discussion.

An objective of the present invention is to provide users with a delivery system for CBD infused edibles, gummies, drinks or other comestibles with improved absorption rate, improved potency and faster effects. The present invention intends to provide users with a formulation and method of making the same, that can absorb in the stomach approximately 500% faster than the normal rate of absorption of CBD infused drinks, oil and gummies. More specifically, the present invention comprises vitamin E TPGS (d-α-Tocopheryl polyethylene glycol 1000 succinate) and Cannabis extract oils, that are formulated/cooked in a specific method to form an aqueous dispersion of Cannabis oil. This cohesive product is soluble in water, oil, gummies and enables increased absorption and bio availability. Further, the present invention causes the CBD to rapidly absorb up to 80 to 90% of every dose administered into the bloodstream, whereas it is only about 35% with other products in the market. Furthermore, the uptake starts almost immediately in all forms of administration, meaning higher potency and faster onset action with each dose. Thus, when the vitamin E TPGS is mixed at the correct temperature and proper mixing time with a CBD isolate or full Spectrum CBD, along with water or hemp seed oil, the result is a unique CBD product that works much better and faster than other products in the market.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a block diagram depicting the ingredients of the present invention.

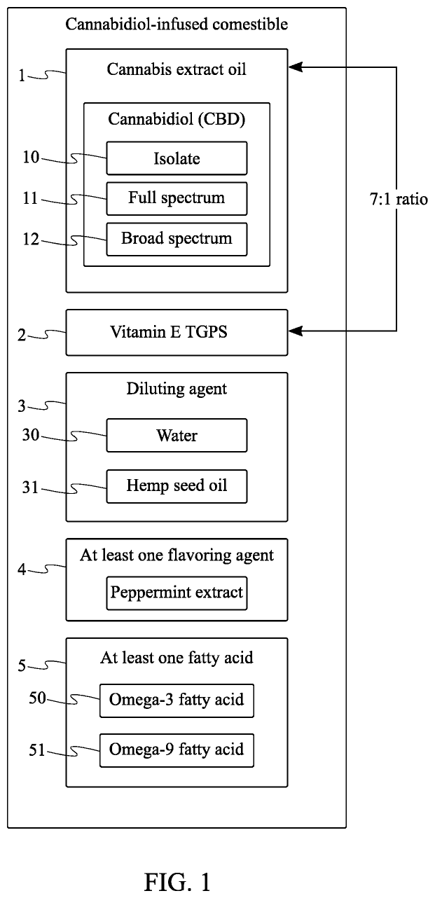

FIG. 2 is a flow diagram depicting the general method of formulation of the present invention.

FIG. 3 is a continuation of FIG. 2.

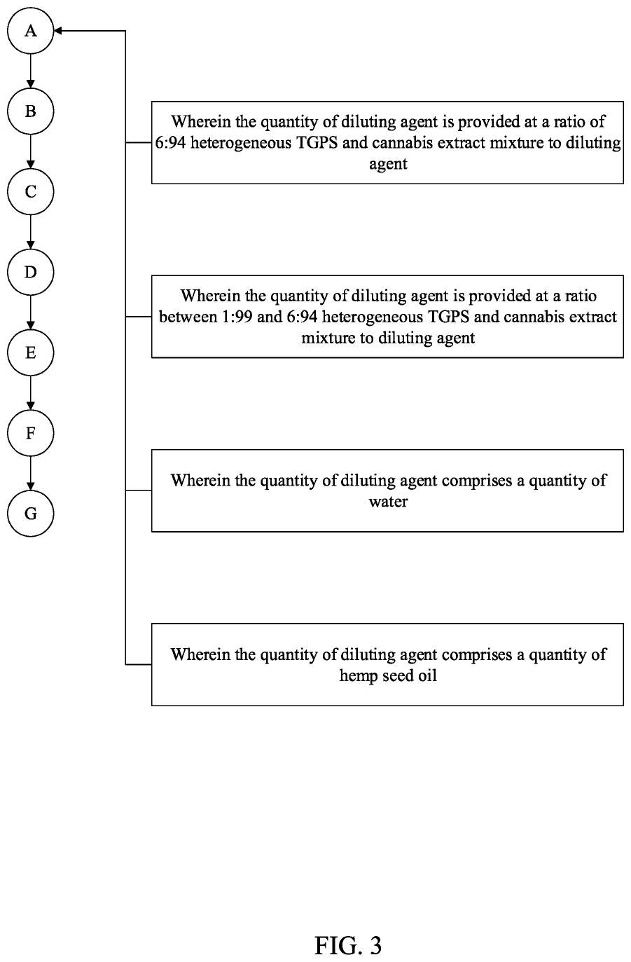

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is a cannabinoid-infused comestible, which may be used to create a final product of a cannabinoid-infused, drink, oil, gummy, or other type of comestible product. More particularly, the primary focus of the present invention is on cannabidiol, or CBD, one of the many cannabinoid compounds present in the Cannabis plant. However, it may be readily understood that the present invention should not be restricted solely to the use of cannabidiol, and may alternatively or additionally use or include one or more other cannabinoids, such as, but not limited to, tetrahydrocannabinol, or THC.

The present invention intends to provide users with a formulation for a CBD infused comestible and method of making the same, that can be absorbed in the stomach approximately 500% faster than the normal rate of absorption of CBD infused drinks, oils, gummies, or other CBD comestibles. More specifically, the present invention comprises vitamin E TPGS (d-α-Tocopheryl polyethylene glycol 1000 succinate) and Cannabis extract oils that are formulated/cooked in a specific method to form an aqueous dispersion of Cannabis oil. This cohesive product is soluble in water, oil and gummies enables increased absorption and bio availability. Further, the present invention enables rapid absorption of up to 80-90% of the CBD contained in every dose administered into the bloodstream, whereas other products currently in the market only offer around 35% absorption. Furthermore, the uptake starts almost immediately in all forms of administration, meaning higher potency and faster on set action with each dose. Thus, when the vitamin E TPGS is mixed at the correct temperature with a CBD isolate or full Spectrum CBD, along with water or hemp seed oil, the result is a unique CBD product that works much better and faster than other products in the market.

In general, in the preferred embodiment of the present invention, the cannabidiol infused comestible of the present invention mainly comprises a quantity of Cannabis extract oil 1 and a quantity of d-α-Tocopheryl polyethylene glycol 1000 succinate, also known as vitamin E TGPS 2. In the preferred embodiment of the present invention, the quantity of Cannabis extract oil 1 and the quantity of vitamin E TGPS 2 are present at a ratio of 7:1 vitamin E TGPS 2 to Cannabis extract oil 1. Though this is the preferred ratio of vitamin E TGPS 2 to Cannabis extract oil 1, it should be readily understood that said ratio may vary in different embodiments, for example, between 6:1 and 8:1 vitamin E TGPS 2 to Cannabis extract oil 1. The said ratio may further depend on the particular concentration of CBD present in the Cannabis extract oil 1.

In the preferred embodiment of the present invention, the Cannabis extract oil 1 is more specifically a CBD extract oil as previously discussed, though in some embodiments the Cannabis extract oil 1 may be a THC extract oil, or an extract oil of one or more other cannabinoids. CBD (empirical formula (2-[1R-3-methyl-6-(1 methylethenyl]-2-cyclohexen-1-yl]-5-pentyl-1,3-benzenediol)) is a mildly psychoactive cannabinoid made from the female hemp Cannabis plant. CBD has an anticonvulsant, anti-inflammatory, anxiolytic effect and is effective against nausea, anxiety, stress, many forms of pain, helps with sleep, hot flashes, digestive issues, and cramps. The quantity of Cannabis extract oil 1 may comprise, but is not limited to, CBD isolate extract oil 10, broad spectrum CBD extract oil 11, or full spectrum CBD extract oil 12.

Vitamin E TPGS (empirical formula C33O3H54(CH2 CH2O), a water-soluble derivative of natural Vitamin E, is a multirole excipient for pharmaceutical drug delivery innovation. Vitamin E TPGS is a non-ionic surfactant which may be used as a solubilizer of poorly soluble drugs, absorption enhancer, emulsifier, stabilizer of Amorphous Solid Dispersion (ASD), vehicle for lipid-based drug formulation, and/or antioxidant. Vitamin E TPGS is also used as an efficient source of natural Vitamin E, both for therapeutic and nutritional purposes. The inclusion of the quantity of vitamin E TGPS 2 in a CBD formulation is the main innovation of the present invention and enables the aforementioned enhanced bioavailability and absorption rate.

Preferably, the cannabinoid-infused comestible of the present invention further comprises a quantity of diluting agent 3. It is noted that the quantity of diluting agent 3 may not be strictly required in all embodiments, but is generally preferred to be included. Particularly, in the preferred embodiment of the present invention, the present invention comprises a quantity of water 30 as the diluting agent 3. This is particularly preferred due to the primary utilization of vitamin E TGPS 2 in the present invention, which is soluble in water. Alternatively, in some embodiments, the quantity of diluting agent 3 may comprise a quantity of hemp seed oil 31, or a quantity of hemp seed oil 31 may be included in addition to a quantity of water 30. The amount of the quantity of diluting agent 3 present in the present invention may vary as desired in order to produce different embodiments of the cannabinoid-infused comestible with different final concentrations of CBD.

In the preferred embodiment, the present invention further comprises at least one flavoring agent 4. In some embodiments, the at least one flavoring agent 4 may comprise pure peppermint extract. However, any other flavoring agents that are known to one of ordinary skill in the art may be included as the at least one flavoring agent 4. The proportion of the at least one flavoring agent 4 in the composition of the cannabinoid-infused comestible of the present invention is herein unspecified and may vary as desired in different embodiments.

Furthermore, in some embodiments, the cannabinoid-infused comestible of the present invention comprises a quantity of at least one fatty acid 5. In some embodiments, the quantity of at least one fatty acid 5 comprises a quantity of omega-3 fatty acid 50, such as, but not limited to, alpha linolenic acid (ALA) or stearidonic acid (SDA). In some embodiments, the quantity of at least one fatty acid 5 comprises a quantity of omega-9 fatty acid 51. In some embodiments, the quantity of at least one fatty acid 5 comprises both a quantity of omega-3 fatty acid 50 and a quantity of omega-9 fatty acid 51. Omega-3 and omega-9 fatty acids have many powerful health benefits for a user's body and brain. Omega-3 supplements may help prevent and treat depression and anxiety, help prevent macular degeneration, which can cause vision impairment and blindness, reduce insulin resistance, fight inflammation, and improve several heart disease risk factors. Omega-9 fatty acids have been shown to increase HDL (“good”) cholesterol and decrease LDL (“bad”) cholesterol, they help eliminate plaque build-up in the arteries, which causes heart attack and stroke. While the quantity of at least one fatty acid 5 is not considered a strict requirement in the present invention, it is a desired inclusion to provide additional benefit to users of the present invention. The proportion of the at least one fatty acid 5 in relation to the aforementioned ingredients in the composition of the cannabinoid-infused comestible is generally immaterial, and the at least one fatty acid 5 may be included in any desired amount.

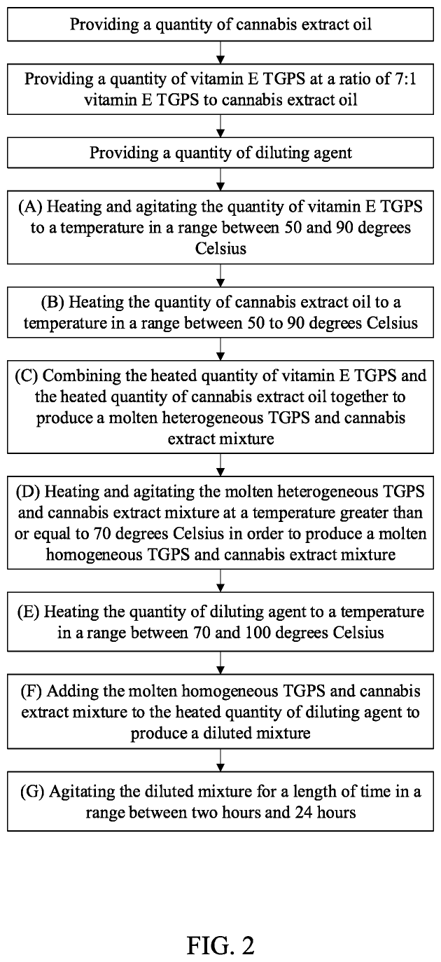

In addition to the composition for the cannabinoid-infused comestible, the present invention further comprises a method of manufacturing the cannabidiol-infused comestible. According to the preferred embodiment of the present invention, the method depicted in FIG. 2 results in the formulation of an aqueous dispersion of Cannabis oil that is absorbed rapidly by the human body after ingestion. In various embodiments, modification of the following method steps may be called for, depending on the physical and chemical characteristics of the choice of active cannabinoid ingredient.

In the method of the present invention, a quantity of Cannabis extract oil 1 is provided as discussed above, in addition to a quantity of vitamin E TGPS 2 at a ratio of 7:1 vitamin E TGPS 2 to Cannabis extract oil 1, and a quantity of diluting agent 3.

In Step A, the quantity of vitamin E TGPS 2 is heated and agitated to a temperature in a range between 50 and 90 degrees Celsius. More particularly, in the preferred embodiment, seven parts of vitamin E TGPS 2 (simply, TGPS 2) for each part of Cannabis extract oil 1 is heated at the approximate temperature of 70-80 degrees Celsius, or 158-176 degrees Fahrenheit, and the TGPS 2 is stirred to ensure homogeneity of the melted TGPS 2.

Separately, subsequent to or simultaneously with Step A, in Step B, the quantity of Cannabis extract oil 1 is heated to a temperature in a range between 50 and 90 degrees Celsius, or more particularly, 70-80 degrees Celsius in the preferred embodiment.

Next, in step C, the heated quantity of vitamin E TGPS 2 and the heated quantity of Cannabis extract oil 1 are combined together to produce a molten heterogeneous TGPS 2 and Cannabis extract mixture.

Next, in Step D, the molten heterogeneous TGPS and Cannabis extract mixture is heated and agitated at a temperature greater than or (approximately) equal to 70 degrees Celsius in order to produce a molten homogeneous TGPS and Cannabis extract mixture. The mixture of TGPS and Cannabis oil is blended thoroughly to obtain homogeneity while a constant temperature above 70 degrees Celsius is maintained in order to ensure prevention of cloudy dispersions due to recrystallization of TGPS. Material produced in step D may be stored at room temperature or refrigerated for later use as indicated in the following steps. Exposure to light, air and high temperature should be limited in order to maintain stability. If allowed to cool, the material will solidify and must be heated back to an approximate temperature of 65-70 degrees Celsius before proceeding to the steps below.

Separately, subsequent to or simultaneously with Step D, in Step E, the quantity of diluting agent 3 is heated to a temperature in a range between 70 and 100 degrees Celsius. More particularly, in some embodiments, the quantity of diluting agent 3 is provided at a ratio of 6:94 heterogeneous TGPS and Cannabis extract mixture to diluting agent 3, as the 6:94 ratio provides optimal dispersion of the mixture. In some embodiments, the quantity of diluting agent 3 is provided at a ratio between 1:99 and 6:94 heterogeneous TGPS and Cannabis extract mixture to diluting agent 3. In the preferred embodiment, the quantity of diluting agent 3 comprises or is provided as a quantity of water 30. Alternatively, in some embodiments, the diluting agent 3 comprises or is provided as a quantity of hemp seed oil 31.

Next, in Step F, the molten homogeneous TGPS and Cannabis extract mixture is added to the heated quantity of diluting agent 3 to produce a diluted mixture. More particularly, the blend of molten TGPS and Cannabis oil is very slowly poured into a quantity of water 30 heated to 70-80 degrees Celsius while stirring. The amount of the quantity of water 30 used depends on the desired concentration of CBD (or alternative or additional cannabinoids, as desired) in the final product to be produced through the method of the present invention. Moreover, the diluted mixture produced in Step F is further diluted to achieve the desired concentration of the Cannabis extract oil 1. Next, in Step G, the diluted mixture is agitated (through stirring, blending or other agitation means) for a length of time in a range between two hours and 24 hours in order to ensure complete dissolution of the mixture. The formulated product produced by the foregoing method may then be collected for future uses such as bottling for sale or production of cannabinoid-infused comestible items such as, but not limited to, drinks, tinctures, baked goods, gummies, or other relevant comestible products. The formulated product should be stored at room temperature or refrigerated, and exposure to light, air, and high temperature should be limited in order to maintain stability.

Thus, in view of the foregoing disclosure, the present invention presents a unique formulation and method of manufacture of a cannabinoid infused comestible that features 82-92% of CBD absorption, at a rate approximately 500% faster than currently available CBD products on the market.

Although the invention has been explained in relation to its preferred embodiment, it is to be understood that many other possible modifications and variations can be made without departing from the spirit and scope of the invention as hereinafter claimed.

What is claimed is:

1. A cannabidiol-infused comestible comprising:
a quantity of Cannabis extract oil; and
a quantity of d-α-Tocopheryl polyethylene glycol 1000 succinate (vitamin E TGPS) at a ratio of 7:1 vitamin E TGPS to Cannabis extract oil.

2. The cannabidiol-infused comestible as claimed in claim 1 comprising:
the Cannabis extract oil comprising cannabidiol (CBD) isolate extract oil.

3. The cannabidiol-infused comestible as claimed in claim 1 comprising:
the Cannabis extract oil comprising broad spectrum CBD extract oil.

4. The cannabidiol-infused comestible as claimed in claim 1 comprising:
the Cannabis extract oil comprising full spectrum CBD extract oil.

5. The cannabidiol-infused comestible as claimed in claim 1 comprising a quantity of diluting agent.

6. The cannabidiol-infused comestible as claimed in claim 5 comprising a quantity of water as the quantity of diluting agent.

7. The cannabidiol-infused comestible as claimed in claim 5 comprising a quantity of hemp seed oil as the quantity of diluting agent.

8. The cannabidiol-infused comestible as claimed in claim 1 comprising at least one flavoring agent.

9. The cannabidiol-infused comestible as claimed in claim 1 comprising a quantity of at least one fatty acid.

10. The cannabidiol-infused comestible as claimed in claim 1 comprising a quantity of omega-3 fatty acid.

11. The cannabidiol-infused comestible as claimed in claim 1 comprising a quantity of omega-9 fatty acid.

12. A method of manufacturing a cannabidiol-infused comestible comprising the steps of:
providing a quantity of Cannabis extract oil;
providing a quantity of vitamin E TGPS at a ratio of 7:1 vitamin E TGPS to Cannabis extract oil;
providing a quantity of diluting agent;
(A) heating and agitating the quantity of vitamin E TGPS to a temperature in a range between 50 and 90 degrees Celsius;
(B) heating the quantity of Cannabis extract oil to a temperature in a range between 50 to 90 degrees Celsius;
(C) combining the heated quantity of vitamin E TGPS and the heated quantity of Cannabis extract oil together to produce a molten heterogeneous TGPS and Cannabis extract mixture;
(D) heating and agitating the molten heterogeneous TGPS and Cannabis extract mixture at a temperature greater than or equal to 70 degrees Celsius in order to produce a molten homogeneous TGPS and Cannabis extract mixture;
(E) heating the quantity of diluting agent to a temperature in a range between 70 and 100 degrees Celsius;
(F) adding the molten homogeneous TGPS and Cannabis extract mixture to the heated quantity of diluting agent to produce a diluted mixture; and
(G) agitating the diluted mixture for a length of time in a range between two hours and 24 hours.

13. The method of manufacturing a cannabidiol-infused comestible as claimed in claim 12, wherein the quantity of diluting agent is provided at a ratio of 6:94 heterogeneous TGPS and Cannabis extract mixture to diluting agent.

14. The method of manufacturing a cannabidiol-infused comestible as claimed in claim 12, wherein the quantity of diluting agent is provided at a ratio between 1:99 and 6:94 heterogeneous TGPS and Cannabis extract mixture to diluting agent.

15. The method of manufacturing a cannabidiol-infused comestible as claimed in claim 12, wherein the quantity of diluting agent comprises a quantity of water.

16. The method of manufacturing a cannabidiol-infused comestible as claimed in claim 12, wherein the quantity of diluting agent comprises a quantity of hemp seed oil.
